(19) United States
(12) Patent Application Publication
(10) Pub. No.: US 2016/0284312 A1
(43) Pub. Date: Sep. 29, 2016

(54) DISPLAY DEVICE AND SENSING DEVICE

(71) Applicant: InnoLux Corporation, Jhu-Nan (TW)

(72) Inventor: Tsan-Po WENG, Jhu-Nan (TW)

(21) Appl. No.: 15/077,297

(22) Filed: Mar. 22, 2016

(30) Foreign Application Priority Data
Mar. 26, 2015 (CN) 201510134781.8

(51) Int. Cl. G09G 5/00; G01T 1/17

(52) U.S. Cl. CPC G09G 5/006; G09G 5/001; G01T 1/17; G09G 2370/045; G09G 2310/08; G09G 2360/18; G09G 2310/0286; G09G 2310/0278; G09G 2310/0297

(57) ABSTRACT

A display device comprises a display panel and a driving module. The driving module is electrically connected to the display panel and comprises a timing control circuit and at least a driving circuit. The timing control circuit outputs a channel control signal. The driving circuit is electrically connected to the timing control circuit and the display panel, and comprises a SPI (serial peripheral interface) decoder, a shift register unit and m signal wires. The SPI decoder receives the channel control signal and outputs a channel number selection signal. The shift register unit receives the channel number selection signal and select n signal wires of the m signal wires according to the channel number selection signal to output n driving signals to the display panel. A sensing device is also disclosed.

### CROSS REFERENCE TO RELATED APPLICATIONS

This Non-provisional application claims priority under 35 U.S.C. §119(a) on Patent Application No(s). 201510134781.8 filed in People's Republic of China on Mar. 26, 2015, the entire contents of which are hereby incorporated by reference

### BACKGROUND

1. Technical Field

The invention relates to a display device and a sensing device, in particular to a display device and a sensing device where the number of the enabled signal wires is programmable.

2. Related Art

With advanced technology, flat display devices have been widely applied to various fields for example LCD (liquid crystal display) devices or organic light-emitting diode (OLED) display devices. Due to advantages of compact volume, low power consumption and low radiation, etc., they gradually replace traditional CRT display devices and are applied to various electronic products for example mobile phone, portable multimedia device, notebook computer, TV, monitor, etc.

Regarding LCD device, it includes a LCD panel and a driving module. The driving module includes a scan driving circuit and a data driving circuit. The scan driving circuit is electrically connected to the LCD panel through a plurality of scan lines, and the data driving circuit is electrically connected to the LCD panel through a plurality of data lines. The scan driving circuit enables the scan lines sequentially. When the scan lines are enabled, the data driving circuit sends data signals for pixels in one row through the data line to the display panel for displaying image.

Usually, the scan driving circuit is made as an integrated circuit (IC), and the scan driving circuit connects the scan lines through the pins of the IC. However, the specifications of display panels are various for different apparatus. If an IC of a certain specification is applied to display panels with different resolutions, pin loss (or called channel loss) occurs because the number of the pins of the IC does not match the number of the scan lines of the panel. For example, if a display panel has 1024 scan lines and an IC has 768 pins, the panel needs two ICs. However, the two ICs have total 768×2=1536 pins, there are 512 remainder pins to be floating, and channel lose is very huge (about 67%).

Assuming applying similar condition to the sensing device for X-ray image, when an electrical signal is converted from sensed X-ray by the light sensing element and then read out through the data line to a signal read-out circuit (e.g. IC), there are floating pins and channel lose because the number of the pins of the signal read-out circuit does not match the number of the data line.

### SUMMARY

An aspect of the disclosure is to provide a display device or a sensing device which determines the number of enabled signal wires depending on actual demand for reducing the channel loss on the signal wires.

An aspect of the disclosure is to provide a display device or a sensing device adapted for various resolutions as convenient as possible.

A display device comprises a display panel and a driving module. The driving module is electrically connected to the display panel and comprises a timing control circuit and at least a driving circuit. The timing control circuit outputs a channel control signal. The driving circuit is electrically connected to the timing control circuit and the display panel, and comprises a SPI (serial peripheral interface) decoder, a shift register unit and m signal wires. The SPI decoder receives the channel control signal and outputs a channel number selection signal. The shift register unit receives the channel number selection signal and selects n signal wires of the m signal wires according to the channel number selection signal to output n driving signals to the display panel, m and n are positive integers, and m≧n.

In one embodiment, the timing control circuit comprises a SPI (serial peripheral interface) encoder, and the SPI encoder outputs the channel control signal to the SPI decoder.

In one embodiment, the shift register unit comprises a plurality of shift registers, and n registers of the shift registers are enabled according to the channel number selection signal.

In one embodiment, the driving circuit further comprises an output buffer unit and a multiplexer unit, the output buffer unit includes the m signal wires, and the multiplexer unit selects n signal wires of the m signal wires according to the channel number selection signal to output the n driving signals.

In one embodiment, the driving circuit is a gate driving circuit or a data driving circuit, and the display device is a LCD device or an OLED display device.

A sensing device comprises a sensing panel and a driving module. The driving module is electrically connected to the sensing panel and comprises a timing control circuit and at least a driving circuit. The timing control circuit outputs a channel control signal. The driving circuit is electrically connected to the timing control circuit and the sensing panel, and comprises a SPI decoder, a shift register unit and m signal wires. The SPI decoder receives the channel control signal and outputs a channel number selection signal. The shift register unit receives the channel number selection signal and selects n signal wires of the m signal wires according to the channel number selection signal to receive n sensing signals from the sensing panel, m and n are positive integers, and m≧n.

In one embodiment, the timing control circuit comprises a SPI encoder, and the SPI encoder outputs the channel control signal to the SPI decoder.

In one embodiment, the shift register unit comprises a plurality of shift registers, and n registers of the shift registers are enabled according to the channel number selection signal.

In one embodiment, the driving circuit further comprises an integration unit and a multiplexer unit, the integration unit includes the signal wires, and the multiplexer unit selects n signal wires of the m signal wires according to the channel number selection signal to receive the sensing signals.

In one embodiment, the driving circuit is a circuit for reading out signal, and the sensing device is a sensing device for X-ray image.

In summary, in the display device, the timing control circuit outputs the channel control signal, the SPI decoder of the driving circuit receives the channel control signal and outputs the channel number selection signal. The shift register unit receives the channel number selection signal, and selects n signal wires of the m signal wires according to the channel number selection signal to output n driving signals to the display panel. In the sensing device, the timing control circuit outputs the channel control signal, and the SPI decoder of the driving circuit receives the channel control signal to output a channel number selection signal. The shift register unit receives the channel number selection signal, and selects n signal wires of the m signal wires according to the channel number selection signal to receive n sensing signals from the sensing panel. Thereby, the number of the signal wires of the driving circuit selected to output the driving signal is configured according to the resolution of the display panel. Besides, the number of the signal wires of the driving circuit selected to receive the sensing signal is configured according to the resolution of the sensing panel. Thus, the loss on the signal wires of the driving circuit is reduced. Moreover, the user has no need to prepare many various kinds of the driving modules or the driving circuits (i.e. amount reduction of different store material).

### BRIEF DESCRIPTION OF THE DRAWINGS

The embodiments will become more understood from the detailed description and accompanying drawings, which are given for illustration only, and thus are not limitative of the present invention, and wherein:

FIG. 1 is a schematic diagram showing a display device according to an embodiment;

FIG. 2 is a schematic diagram showing the connection of the driving module and the display panel in the display device according to an embodiment;

FIG. 3 is a schematic diagram showing a display device according to an embodiment; and

FIG. 4 is a schematic diagram showing a sensing device according to an embodiment.

### DETAILED DESCRIPTION OF THE INVENTION

The embodiments of the invention will be apparent from the following detailed description but non-limiting embodiments, which proceeds with reference to the accompanying drawings, wherein the same references relate to the same elements.

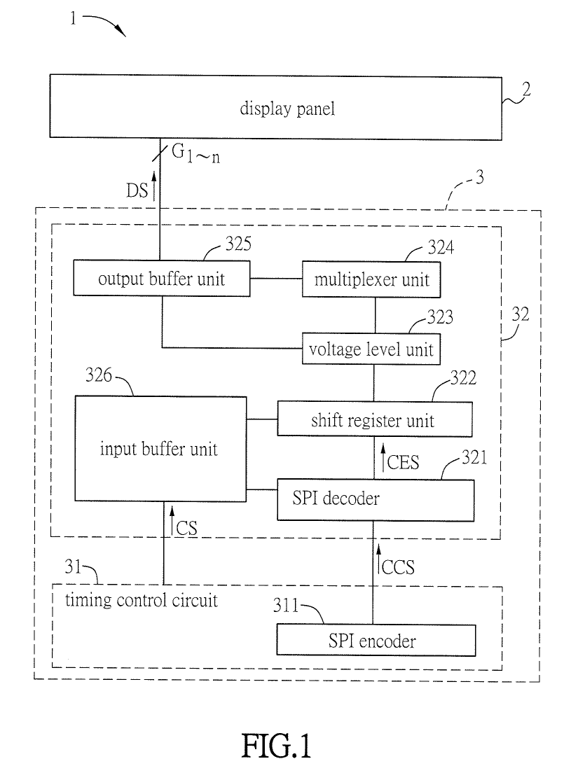

Referring to FIG. 1, it is a schematic diagram showing a display device according to an embodiment.

As shown in FIG. 1, the display device 1 comprises a display panel 2 and a driving module 3. The display device 1 may be a LCD device or an OLED display device. In the embodiment, the display panel 2 is a LCD panel and comprises a plurality of scan lines and data lines.

The driving module 3 is electrically connected to the display panel 2, and comprises a timing control circuit 31 and at least a driving circuit 32. The number of the driving circuit 32 is one in the embodiment. Besides, the driving circuit 32 is electrically connected to the timing control circuit 31 and the display panel 2. The driving circuit 32 may be a gate driving circuit or a data driving circuit. In the embodiment, the driving circuit 32 is a gate driving circuit, and a driving signal DS outputted from the driving circuit 32 to the display panel 2 is a scan driving signal. The driving module 3 or the driving circuit 32 is an IC (integrated circuit) and sends the driving signal DS through the pin (or called channel) of the IC to the corresponding scan line of the display panel 2. In other embodiment, the driving module 3 or the driving circuit 32 is an ordinary electronic component, and also connects to the corresponding scan lines of the display panel 2.

The timing control circuit 31 outputs a channel control signal CCS. The driving circuit 32 comprises a SPI (serial peripheral interface) decoder 321, a shift register unit 322 and m signal wires. The driving circuit (gate driving circuit) 32 further comprises a voltage level unit 323, a multiplexer unit 324, an output buffer unit 325 and an input buffer unit 326.

The timing control circuit 31 comprises a SPI (serial peripheral interface) encoder 311, and the SPI encoder 311 output the channel control signal CCS to the SPI decoder 321 of the driving circuit 32. The SPI can transmit data of synchronous serial communication protocol, usually there are requires 3 signal wires or 4 signal wires. In the embodiment, the SPI encoder 311 acts as a master controller, and the SPI decoder 321 acts as a slave controller. The SPI encoder 311 and the SPI decoder 321 are utilized to control the number of the selected signal wires of the driving circuit 32 for outputting the driving signals DS. Thus, the user can choose the number of the driving signals based on the number of the scan line of the display panel 2 and the number of the signal wires of the driving circuit 32 for lowering the channel (pin) loss of the driving circuit 32.

The SPI encoder 311 generates the channel control signal CCS by encoding the number of the to-be-selected signal wires by the user. The SPI decoder 321 can receive the channel control signal CCS and decode the channel control signal CCS since the SPI decoder 321 and the SPI encoder 311 use the same communication protocol. Thus, the SPI decoder 321 receives the channel control signal CCS to output a channel number selection signal CES according to the channel control signal CCS to set the number of the enabled shift register unit 322. Thus, n signal wires G₁₋ₙ are selected of the m signal wires of the driving circuit 32 to output n driving signals DS to the display panel 2, m and n are positive integers, and m≧n. In the embodiment, the shift register unit 322 is electrically connected to these signal wires. After the SPI decoder 321 decodes the channel control signal CCS, it is determined that which signal wires are selected by the user to output the driving signals DS to the corresponding scan lines of the display panel 2 (i.e. obtaining the information about setting number of the selected channels for the driving circuit 32). Thus, the driving module is able to meet the number of the scan lines of the display panel 2 with various resolution.

The shift register unit 322 includes at least m shift registers (not shown). In the embodiment, the shift registers are in a cascade and shift in left-to-right direction or in right-to-left direction selectively with respect to the scan signal of the display panel 2 in top-to-bottom direction or bottom-to-top direction. Moreover, the input buffer unit 326 is electrically connected to the timing control circuit 31, the SPI decoder 321 and the shift register unit 322. The input buffer unit 326 can receive a control signal CS (e.g. vertical clock signal, vertical synchronization signal) outputted from the timing control circuit 31 and send the control signal CS to the shift register unit 322. The shift register unit 322 can control operation period of each shift register according to the channel number selection signal CES to sequentially enable the shift registers of the shift register unit 322 one by one Each shift register sequentially latches and stores the control signal CS outputted from the timing control circuit 31. Moreover, the SPI decoder 321 receives the channel control signal CCS and outputs the channel number selection signal CES. In the shift register unit 322, n registers of the m shift registers are enabled according to the channel number selection signal CES. In other words, the decoded channel number selection signal CES can control which shift registers of the shift register unit 322 are enabled to output signals (the remainder shift registers are disabled and do not output).

The voltage level unit 323 is electrically connected to the shift register unit 322, the multiplexer unit 324 and the output buffer unit 325. The voltage level unit 323 can receive n output signals from n shift registers of the shift register unit 322 (n shift registers are enabled), and output another signal to the output buffer unit 325. The voltage level unit 323 can convert the logic voltage, for example 3V/0V or 5V/0V, into a turn-on voltage above 20V or a turn-off voltage below −5V for controlling the pixel switch device of the display panel 2.

The output buffer unit 325 includes the m signal wires (m is greater than or equal to n), and the multiplexer unit 324 selects n signal wires G₁₋ₙ of the m signal wires according to the channel number selection signal CES to output n driving signals DS. The n driving signals DS are transmitted through the n signal wires G₁₋ₙ to the display panel 2. In other words, the multiplexer unit 324 is informed of the number(s) of the enabling or disabling shift registers from the channel number selection signal CES and lets the output buffer unit 325 know that output buffering should be stopped on which signal wire (i.e. which channel) (n channels are buffered to output the driving signals DS, the remainder channels do not output the driving signals DS). Thus, n signal wires G₁₋ₙ of the driving circuit 32 can output n driving signals DS to the corresponding scan lines of the display panel 2. Therefore, the user can choose a proper configuration according to the number of the signal wires of the driving circuit 32 and the resolution of the display panel 2 for properly connecting n signal wires G₁₋ₙ to n corresponding scan lines. Therefore, the driving signals DS (scan signals) can be correspondingly transmitted through n signal wires G₁₋ₙ to n scan lines of the display panel 2.

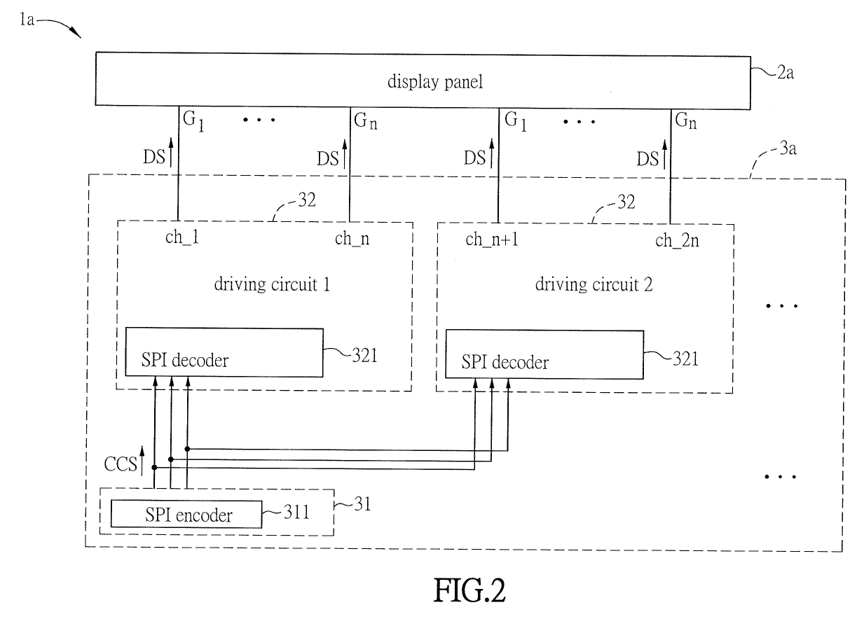

As mentioned above, in the embodiment, the SPI encoder 311 of the timing control circuit 31 outputs the channel control signal CCS to the SPI decoder 321, and then the SPI decoder 321 set the number of the enabled shift register unit 322 according to the channel control signal CCS, so n signal wires G₁₋ₙ of the driving circuit 32 are selected to output the driving signals DS to the display panel 2. Because the display device 2 in the embodiment can set the number of the signal wires of the driving circuit 32 for outputting the driving signals DS depending on the resolution of the display panel 2, referring to FIG. 2, the user can choose a proper configuration according to the resolution of the display panel 2a (the number of the scan lines) and the number of the signal wires of the driving circuit 32 of the driving module 3a for reducing the loss on the signal wires (channel/pin loss) of the driving circuit 32. Moreover, the user has no need to prepare many various kinds of the driving module 3 or the driving circuit 32 (i.e. reduction of different ready IC). It is more convenient to utilize the driving module 3 or the driving circuit 32 to meet the display panel 2a with various resolution.

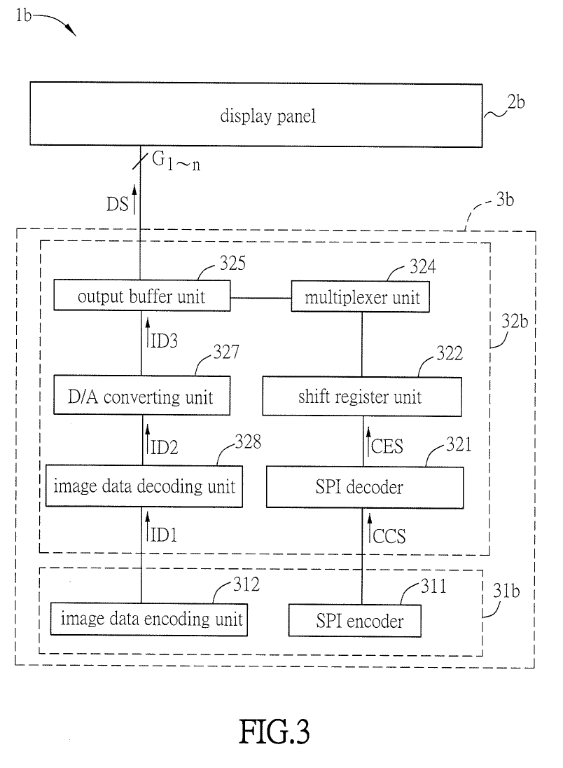

Besides, referring to FIG. 3, it is a schematic diagram showing a display device 1b according to another embodiment. In the embodiment, the display panel 2b is still a LCD panel, for example, and the driving circuit 32b is a data driving circuit, for example.

Compared with the driving module 3 in FIG. 1, the timing control circuit 31b further comprises an image data encoding unit 312. Moreover, in addition to the SPI decoder 321, the shift register unit 322, the multiplexer unit 324 and the output buffer unit 325, the driving circuit 32b further comprises a D/A converting unit 327 and an image data decoding unit 328 but the driving circuit 32b excludes the voltage level unit 323.

In the embodiment, similarly, the SPI encoder 311 and the SPI decoder 321 are utilized to control the number of the signal wires (i.e. G₁₋ₙ) of the output buffer unit 325 of the driving circuit 32b which are allowed to output the driving signals DS. Besides, the image data encoding unit 312 can encode video signals received from external interface to output a first image data ID1. The image data decoding unit 328 receives the first image data ID1 and then decodes the first image data ID1 to obtain a second image data ID2. The second image data ID2 is converted into a third image data ID3 from digital to analog by D/A converting unit 327 and then transmitted to the output buffer unit 325. The image data signals (i.e. the driving signals DS) are outputted through n signal wires G₁₋ₙ of the output buffer unit 325 to the display panel 2. Moreover, the timing control circuit 31b can send a horizontal clock signal and a horizontal synchronization signal to the driving circuit 3b (not shown), and then the driving circuit 3b drives the display panel 2b with the image data signals (the driving signals DS), the horizontal clock signal and the horizontal synchronization signal to display image.

Because other illustrations for the display device 1b may refer to the corresponding elements of the display device 1, they are not repeated here.

From the above embodiments, by the SPI encoder and the SPI decoder, the driving module handles the number of the signal wires allowed to output the driving signals. These elements can be applied to the scan driving circuit (Scan driver IC) and the data driving circuit (Data driver IC) at the same time. Thereby, it is adapted for the display panel with different resolution and the loss on the signal wires of the driving module (channel loss) is lowered. The quantity of various kinds of ready driving module or the driving circuit (IC) is reduced so it is more convenient to use.

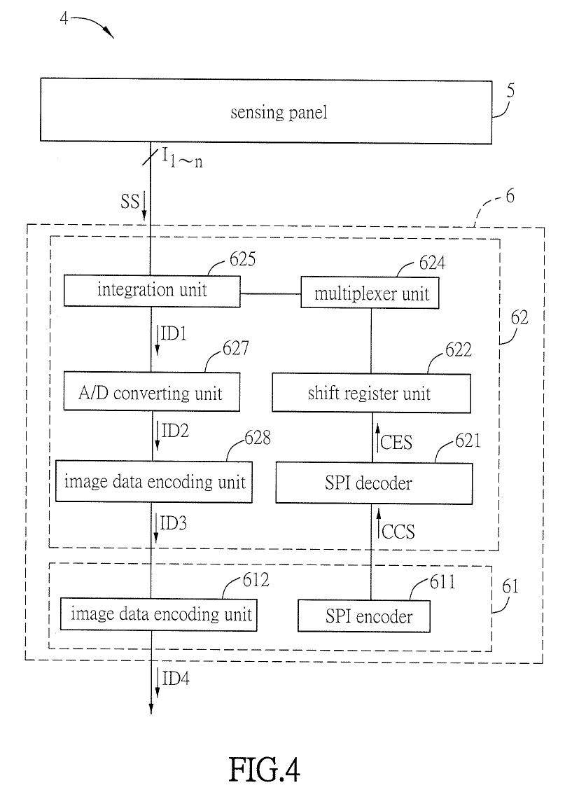

Referring to FIG. 4, it is a schematic diagram showing a sensing device 4 according to an embodiment.

Referring to FIG. 4, the sensing device 4 comprises a sensing panel 5 and a driving module 6. In the embodiment, the sensing device 4 is a sensing device for X-ray image and the sensing panel 5 can sense X-ray to output an electrical signal. After X-ray enters the sensing panel 5, the sensing panel 5 converts the X-ray into visible light and then converts the sensed visible light into an electrical signal by a light sensing element. Then, the electrical signal is read out through a plurality of data lines of the sensing panel 5 (read out by the driving module 6). After image processing, the sensed image can be shown on for example a display device.

The driving module 6 is electrically connected to the sensing panel 5, and comprises a timing control circuit 61 and at least a driving circuit 62. In the embodiment, the number of the driving circuit 62 is one for example. Moreover, the driving circuit 62 is electrically connected to the timing control circuit 61 and the sensing panel 5. In the embodiment, the driving circuit 62 is a circuit for reading out signal. The driving circuit 62 receives (read out) a sensing signal SS from the sensing panel 5. The sensing signal SS is an electrical signal outputted from the sensing panel 5 after the sensing panel 5 senses X-ray. For example, the driving circuit 62 may be made as an IC to receive the sensing signal SS from the sensing panel 5 by an IC pin (or called channel). However, the driving circuit 62 may be made as an ordinary electronic component rather than IC, and the driving circuit 62 can similarly connect to the corresponding data lines of the sensing panel 5.

The timing control circuit 61 outputs a channel control signal CCS. The driving circuit 62 has a SPI decoder 621, a shift register unit 622 and m signal wires. Besides, the driving circuit 62 in the embodiment further comprises a multiplexer unit 624, an integration unit 625, an A/D converting unit 627 and an image data encoding unit 628.

The timing control circuit 61 comprises a SPI encoder 611, and the SPI encoder 611 can output the channel control signal CCS to the SPI decoder 621 of the driving circuit 62. The SPI can transmit data of synchronous serial communication protocol, and usually SPI requires 3 signal wires or 4 signal wires. In the embodiment, the SPI encoder 611 acts as a master controller, and the SPI decoder 321 acts as a slave controller. The SPI encoder 611 and the SPI decoder 621 are utilized to control the number of the selected signal wires of the driving circuit 62 for receiving the sensing signals SS. Thus, the user can choose the number of the driving signals based on the number of the data line of the sensing panel 5 and the number of the signal wires of the driving circuit 62 to lower the channel (pin) loss of the driving circuit 62.

The SPI encoder 611 generates the channel control signal CCS by encoding the number of the to-be-selected signal wires by the user. The SPI decoder receives the channel control signal CCS and decode the channel control signal CCS since the SPI decoder 621 and the SPI encoder 611 use the same communication protocol. Thus, the SPI decoder 621 receives the channel control signal CCS to set the number of the enabled shift register unit 622 according to the channel control signal CCS. Thus, n signal wires I₁₋ₙ are selected from the m signal wires of the driving circuit 62 to receive n sensing signals SS from the sensing panel 5, m and n are positive integers, and m≧n. After the SPI decoder 621 decodes the channel control signal CCS, it is determined that which signal wires are selected by the user to receive the sensing signals SS from the corresponding data lines of the sensing panel 5 (i.e. obtaining the information about setting number of the selected channels for the driving circuit 62). Thus, the driving module is able to meet the number of the data lines of the sensing panel 5 with various resolution.

The shift register unit 622 includes at least m shift registers (not shown). In the embodiment, these shift registers are in a cascade. The SPI decoder 621 receives the channel control signal CCS to output a channel number selection signal CES according to the channel control signal CCS. In the shift register unit 622, n shift registers of the m shift registers are enabled according to the channel number selection signal CES. In other words, the decoded channel number selection signal CES decoded by the SPI decoder 621 can control which shift registers of the shift register unit 622 are enabled to output signals (the remainder shift registers are disabled and do not output).

The integration unit 625 is coupled to the signal wires (their number is greater than or equal to n), and the multiplexer unit 624 can select n signal wires I₁₋ₙ of the m signal wires for receiving the sensing signal SS according to the channel number selection signal CES. The driving circuit 62 receives n sensing signals SS from the sensing panel 5 through these n signal wires I₁₋ₙ. In other words, the multiplexer unit 624 is informed of the number(s) of the enabling and disabling shift registers from the channel number selection signal CES, and lets the integration unit 625 know that reception of the sensing signal SS should be stopped on which signal wire (i.e. which channel) (n channels receive the sensing signals SS, the remainder channels do not receive the sensing signal SS). Thus, n signal wires I₁₋ₙ of the driving circuit 62 can receive n sensing signals SS from the corresponding data lines of the sensing panel 5. Therefore, the user can choose a proper configuration according to the number of the signal wires of the driving circuit 62 and the resolution of the sensing panel 5 for properly connecting n signal wires I₁₋ₙ to n corresponding data lines. Therefore, the electrical signals (i.e. the sensing signal SS) outputted from the data line can be transmitted through n signal wires to the driving module 6.

The integration unit 625 integrates the sensing signal SS to output a first image data ID1. The first image data ID1 is converted to a second image data ID2 from analog to digital by an A/D converting unit 627, and then the second image data ID2 is transmitted to the image data encoding unit 628. The image data encoding unit 628 decodes the second image data ID2 to output a third image data ID3 to an image data decoding unit 612 of the timing control circuit 61. After decoded by the image data decoding unit 612, a fourth image data ID4 is outputted to a display device (not shown). The image sensed by the X-ray is shown by the display device.

As mentioned above, in the embodiment, the SPI encoder 611 of the timing control circuit 61 outputs the channel control signal CCS to the SPI decoder 621, and then the SPI decoder 621 set the number of the enabled shift register unit 622 according to the channel control signal CCS, so n signal wires I₁₋ₙ of the m signal wires of the driving circuit 62 are selected to read out the sensing signals SS from the sensing panel 5 to obtain the image. Because the sensing device 4 in the embodiment can set the number of the signal wires of the driving circuit 62 for receiving the sensing signals SS depending on the resolution of the sensing panel 5, the user can choose a proper configuration according to the number of the data lines of the sensing panel 5 and the number of the signal wires of the driving circuit 62 of the driving module 6 for reducing the loss on the signal wires (channel/pin loss) of the driving circuit 62. Moreover, the user has no need to prepare various kinds of the driving module 6 or the driving circuit 62 (i.e. reduction of different ready IC for reading out data). It is more convenient to utilize the driving module 6 or the signal wires of the driving circuit 62 to meet the sensing panel 5 with different resolution.

In summary, in the display device, the timing control circuit outputs the channel control signal, the SPI decoder of the driving circuit receives the channel control signal and outputs the channel number selection signal. The shift register unit receives the channel number selection signal, and selects n wires of the m signal wires according to the channel number selection signal to output n driving signals to the display panel. In the sensing device, the timing control circuit outputs the channel control signal, and the SPI decoder of the driving circuit receives the channel control signal to output a channel number selection signal. The shift register unit receives the channel number selection signal, and selects n signal wires of the m signal wires according to the channel number selection signal to receive n sensing signals from the sensing panel. Thereby, the number of the signal wires of the driving circuit allowed to output the driving signal is configured or set according to the resolution of the display panel. Besides, the number of the signal wires of the driving circuit selected to receive the sensing signal is configured according to the resolution of the sensing panel. Thus, the loss on the signal wires of the driving circuit is reduced. Moreover, the user may has no need to prepare many various kinds of the driving modules or the driving circuits (i.e. amount reduction of different store material).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display panel; and
a driving module electrically connected to the display panel and comprising:
a timing control circuit outputting a channel control signal; and
at least a driving circuit electrically connected to the timing control circuit and the display panel, and comprising a SPI (serial peripheral interface) decoder, a shift register unit and m signal wires electrically connected to the display panel, wherein the SPI decoder receives the channel control signal and outputs a channel number selection signal, the shift register unit receives the channel number selection signal and select n signal wires of the m signal wires to output n driving signals to the display panel, m and n are positive integers, and m≧n.

2. The display device of claim 1, wherein the timing control circuit comprises a SPI encoder, and the SPI encoder outputs the channel control signal to the SPI decoder.

3. The display device of claim 1, wherein the shift register unit comprises a plurality of shift registers, and n registers of the shift registers are enabled according to the channel number selection signal.

4. The display device of claim 3, wherein the driving circuit further comprises an output buffer unit and a multiplexer unit, the output buffer unit including the m signal wires, and the multiplexer unit selects the n signal wires of the m signal wires according to the channel number selection signal to output the n driving signals.

5. The display device of claim 1, wherein the driving circuit is a gate driving circuit or a data driving circuit, and the display device is a LCD device or an OLED display device.

6. A sensing device, comprising:
a sensing panel; and
a driving module electrically connected to the sensing panel and comprising:
a timing control circuit outputting a channel control signal; and
at least a driving circuit electrically connected to the timing control circuit and the sensing panel, and comprising a SPI decoder, a shift register unit and m signal wires electrically connected to the shift register unit, wherein the SPI decoder receives the channel control signal and outputs a channel number selection signal, the shift register unit receives the channel number selection signal and select n signal wires of the m signal wires to receive n sensing signals from the sensing panel, m and n are positive integers, and m≧n.

7. The sensing device of claim 6, wherein the timing control circuit comprises a SPI encoder, and the SPI encoder outputs the channel control signal to the SPI decoder.

8. The sensing device of claim 6, wherein the shift register unit comprises a plurality of shift registers, and n registers of the shift registers are enabled according to the channel number selection signal.

9. The sensing device of claim 8, wherein the driving circuit further comprises an integration unit and a multiplexer unit, the integration unit including the signal wires, and the multiplexer unit selects the n signal wires of the m signal wires according to the channel number selection signal to receive the sensing signals.

10. The sensing device of claim 6, wherein the driving circuit is a circuit for reading out signal, and the sensing device is a sensing device for X-ray image.
